(19) United States
(12) Patent Application Publication
(10) Pub. No.: US 2010/0134719 A1
(43) Pub. Date: Jun. 3, 2010

(54) NanoEmbossed shapes and fabrication methods of wire grid polarizers

(76) Inventors: Chad Johns, San Leandro, CA (US); Erik Egan, Oakland, CA (US); Michael J. Little, Garden Valley, CA (US)

Correspondence Address: LUMEN PATENT FIRM, 350 Cambridge Avenue, Suite 100, PALO ALTO, CA, 94306, US

(21) Appl. No.: 12/733,037

(22) PCT Filed: Jul. 24, 2008
(86) PCT No.: PCT/US08/71076

§ 371 Date: Feb. 2, 2010

Related U.S. Application Data
(60) Provisional application No. 60/953,652, filed on Aug. 2, 2007.
(60) Provisional application No. 60/953,658, filed on Aug. 2, 2007.
(60) Provisional application No. 60/953,668, filed on Aug. 2, 2007.
(60) Provisional application No. 60/953,671, filed on Aug. 2, 2007.

(51) Int. Cl. G02F 1/1335; G02B 5/30; B05D 5/06

(52) U.S. Cl. 349/62; 359/486; 427/162

(57) ABSTRACT

A wire grid polarizer may be formed by embossing a substrate surface with a mold having a plurality of grooves to form raised ridges; and depositing a metal line profile onto the ridges through one or more baffles oriented at an oblique angle to the normal of the substrate. The metal line profile is characterized by a cross-sectional width that tapers such that the metal line profile is wider proximate a vertex of the ridges than proximate a base of the ridges. A wire grid polarizer may comprise a substrate with a plurality of raised ridges and a plurality of metal lines on the raised ridges. The metal lines are characterized by cross-sectional metal line profiles having triangular shapes with a tip down configuration. Such a wire grid polarizer may be used in a liquid crystal display.

### CLAIM OF PRIORITY

This application clams the benefit of priority of U.S. Provisional Patent Application No. 60/953,668, filed Aug. 2, 2008, the entire contents of which are incorporated herein by reference.

This application clams the benefit of priority of U.S. Provisional Patent Application No. 60/953,652, filed Aug. 2, 2008, the entire contents of which are incorporated herein by reference.

This application clams the benefit of priority of U.S. Provisional Patent Application No. 60/953,658, filed Aug. 2, 2008, the entire contents of which are incorporated herein by reference.

This application clams the benefit of priority of U.S. Provisional Patent Application No. 60/953,671, filed Aug. 2, 2008, the entire contents of which are incorporated herein by reference.

### CROSS-REFERENCE TO RELATED APPLICATIONS

This application is related to International Patent Application PCT ______, (Attorney Docket Number AGT-005/PCT, to Michael J. Little, entitled “A WIRE GRID POLARIZER WITH COMBINED FUNCTIONALITY FOR LIQUID CRYSTAL DISPLAYS”, filed the same day as the present application, the entire contents of which are incorporated herein by reference.

This application is related to International Patent Application PCT ______, (Attorney Docket Number AGT-006/PCT, to Michael J. Little, entitled “A METHOD FOR OBLIQUE VACUUM DEPOSITION FOR ROLL-ROLL COATING OF WIRE GRID POLARIZER LINES ORIENTED IN A DOWN-WEB DIRECTION”, filed the same day as the present application, the entire contents of which are incorporated herein by reference.

### FIELD OF INVENTION

Embodiments of the present invention relate to wire grid polarizers and more particularly to wire grid polarizers having optimum optical performance as a polarization recycling element in liquid crystal displays.

### BACKGROUND OF INVENTION

Liquid Crystal Displays (LCD) have become the dominant display technology for applications ranging from cell phones to large screen TVs. The major components of a basic LCD are a backlight unit and a liquid crystal (LC) array which is disposed between front and rear polarizers. The backlight unit creates a bright, uniform illumination for the LC array, which modulates the illumination on a pixel-by-pixel basis in proportion to the voltage applied to each pixel of the LC array.

The most important attributes of a LCD, outside of the cost, which is always preeminent, are contrast and brightness. Generally in LCDs, higher contrast and higher brightness can only be achieved at a higher cost. In nearly all instances, because the human eye is very discerning, display manufacturers can only use polarizers with a contrast ratio of several thousand to one. However, high contrast polarizers absorb a larger fraction of the illumination and therefore reduce brightness.

The baseline engineering approach for increasing the brightness of LCDs is to increase the number of lamps used in the backlight assembly or to increase the power to the lamps. These methods adversely impact power consumption, which is a severe penalty for the ever-increasing number of battery-operated devices with displays. Several innovative solutions have been developed which enable brighter LCDs that provide sufficiently high contrast without increasing costs as much as the baseline engineering approach.

An innovative approach to increase the brightness efficiency of LCDs is known as polarization recycling. A typical backlight assembly emits light with equal amounts of both planes of polarization, but the rear absorptive polarizer absorbs essentially all of one polarization while transmitting a majority of light with the desired plane of polarization. Thus, slightly more than ½ of the light generated by the backlight assembly is absorbed by the rear polarizer and never reaches the viewer. By adding a polarization recycling film (which in effect is a low contrast reflective polarizer) between the backlight assembly and the rear polarizer, the majority of the light with an undesired plane of polarization is reflected back towards the backlight and is not lost to absorption. The reflected light undergoes multiple scattering events that ultimately cause it to return in the direction towards the viewer. During the multiple scattering events undergone by this reflected light, its plane of polarization is rotated so that some of the light with undesired plane of polarization is converted into light with the desired plane of polarization, and this light is now transmitted by the polarization recycling film and the absorptive polarizer. This process is recursive with the net result that some of the light that would have ordinarily been absorbed by the absorptive polarizer is effectively converted to light with the desired plane of polarization and it now contributes to the brightness seen by the viewer. Polarization recycling films suitable for this type of brightness enhancement can be made with chiral films (e.g., as described in U.S. Pat. No. 6,099,758), multi-layer stacks of isotropic and anisotropic layer pairs (e.g., as described in U.S. Pat. No. 5,965,247) and wire grid polarizers (e.g., as described in US Patent Application Publications 20060061862 and 20060118514, which are incorporated herein by reference).

It is noted that in the polarization recycling configuration described above, the rear polarizer is not replaced; it must remain to provide the high contrast desired for the display. Most LCD applications require contrast ratios in the range of several thousand to one; the contrast of typical polarization recycling films are in the range of 10:1 to 30:1 and thus, if used without a rear polarizer cannot meet the desired high contrast levels. However, adding a polarization recycling film with even this modest level contrast to an LCD has been shown to provide brightness improvements of 50% or larger. However, the cost of adding this polarization recycling film must be traded off against the cost of other methods that might provide an equivalent brightness to the viewer.

A further innovation to the polarization recycling method of brightness enhancement is described in U.S. Pat. No. 6,025,897 and US Patent Application Publication 20060118514 both of which are incorporated herein by reference. A high contrast, high transmission reflective polarizer (e.g., wire grid polarizer) is used to provide the same functionality as a high contrast absorptive polarizer combined with a polarization recycling film. This further innovation has the major benefit of significantly reducing costs and simplifying manufacturing by eliminating an extra layer of the LCD. However, the presently available wire grid polarizer designs that are capable of meeting the needs for high contrast and high transmission fall short of the low cost and large area requirements for the rapidly growing TV market; e.g. 52″ diagonal flat panel LCD TVs. Also, the presently available wire grid polarizer designs that can meet the large area and low cost criteria fall short of providing the optimal contrast and transmission demanded.

Thus, there is a need for a design and manufacturing method for reflective polarizers that can achieve both a high contrast ratio and high transmission of light with the desired plane of polarization yet be produced for large areas at a low cost. As used herein, contrast refers to the ratio of intensity of the transmitted light with a desired plane of polarization to intensity of the light with an orthogonal plane of polarization. As used herein, the transmission of a polarizer is defined as the percentage of incident unpolarized light that is transmitted by the polarizer.

### BRIEF DESCRIPTION OF THE DRAWINGS

The teachings of the present invention can be readily understood by considering the following detailed description in conjunction with the accompanying drawings, in which:

FIG. 1 illustrates an example of a basic liquid crystal display (LCD) assembly as they are currently used.

FIG. 2 illustrates one embodiment of polarization recycling in a basic LCD.

FIGS. 3A-3B describe the principle of polarization recycling.

FIG. 4 illustrates an improved implementation of polarization recycling in LCDs.

FIG. 5 illustrates a typical wire grid polarizer.

FIGS. 6A-6D illustrate several prior art metal line cross-sections for wire grid polarizers.

FIGS. 7A-7C schematically illustrate an embossing process for fabricating a substrate having a desired shape for use in a wire grid polarizer.

FIGS. 8A-8C schematically illustrate an oblique deposition process used in fabricating wire grid polarizers according to prior art.

FIGS. 9A-9E illustrate several prior art nanoembossed shapes used with the oblique metal deposition process to produce wire grid polarizers.

FIGS. 10A-10E illustrate the metal line cross-sectional shape resulting from oblique deposition onto the nanoembossed shapes of FIGS. 9A-9E.

FIG. 11A illustrates the coordinate system and the description of the angular distribution of flux emitted by a deposition source.

FIG. 11B illustrates a plot of a cosine flux distribution.

FIG. 12A-12C illustrate Monte Carlo computer simulations of the oblique angle deposition of metal onto prior art nanoembossed shapes.

FIG. 13 illustrates a Monte carol computer simulation of the result of depositing metal onto one preferred nanoembossed shape with no oblique angle and no control of the angular flux distribution of the metal deposition flux.

FIG. 14A-14C illustrates the use of baffles to control the angular flux distribution during metal deposition.

FIG. 15A-15B illustrate the tilting of baffles to control both the angular flux distribution and the mean deposition angle (i.e., the oblique angle).

FIGS. 16A-16F are cross-sectional diagrams of computer simulations that illustrate the dependency of the metal line profile on the metal deposition parameters.

FIG. 17A-17D illustrate the results of Monte Carlo simulations for specific examples of preferred structures and the resulting triangular metal line shapes according to embodiments of the present invention wherein both a preferred angular flux distribution and a preferred oblique angle of incidence have been used.

FIGS. 18A and 18B illustrate the two preferred embodiments of the nanoembossed shapes and the preferred embodiments of the metal line profiles achieved with optimally controlled angular flux distribution with oblique angle vacuum metallization.

### SUMMARY OF THE INVENTION

Embodiments of the present invention provide wire grid polarizers with both sufficiently high transmission and contrast ratio for use in polarization recycling in LCDs capable of being produced for large areas at a low cost. Embodiments of the present invention achieve both high contrast ratio and high light transmission utilizing fabrication technology consisting of (1) creating nanoscale surface features on a thin polymer film with an embossing process that is followed by (2) an oblique deposition of metal. While there have been prior attempts to use this low cost approach for various applications, including polarization recycling in LCDs, the innovation of nanoembossed shapes with controlled angular flux of the oblique deposition results in reflective polarizers with both higher contrast and higher transmission; sufficient for the needs of the LCD industry.

As will be shown, the transmission and contrast of a wire grid polarizer depends on the cross-sectional shape of the metal lines. Prior attempts to achieve optimal cross-sectional line shapes are not scalable to large areas. Prior art wire grid polarizer approaches that are capable of scaling to large areas at low cost have not been able to achieve the optimal cross-sectional shape of the metal lines that are needed to achieve high contrast ratios simultaneously with high transmission. Embodiments of the present invention provide the means to achieve an optimal cross-sectional shape of metal lines through the combination of controlling the angular flux distribution during oblique deposition along with optimizing curved peak shapes of the surface topographic features.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

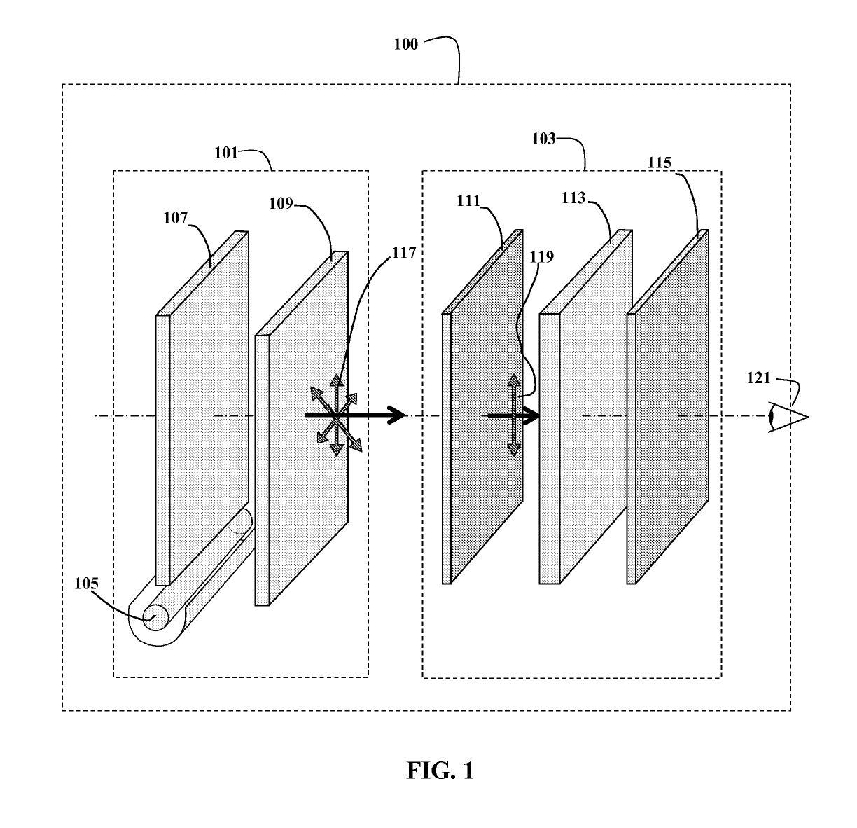

As shown in FIG. 1, in its minimal form, a liquid crystal display (LCD) 100 includes two major sub-assemblies, a backlight assembly 101 and a liquid crystal (LC) panel assembly 103. The backlight assembly 101 is minimally composed of a light source 105, a light guide 107, and a diffuser 109 to homogenize the spatial variations in the intensity of the light emanating from the backlight assembly 101. The illumination 117 provided by the backlight assembly 101 is typically unpolarized. The liquid crystal panel assembly 103 is minimally composed of a rear absorptive polarizer 111 and a front absorptive polarizer 115 on either side of a liquid crystal array 113. Unpolarized light 117 emanating from the backlight assembly 101 is converted to polarized light 119 by the rear absorptive polarizer 111; light with a desired plane of polarization 119 is transmitted by the rear absorptive polarizer 115 while light with the orthogonal plane of polarization is absorbed by the rear absorptive polarizer 111. Light with the desired plane of polarization 119 that is transmitted by the rear absorptive polarizer 111 is subsequently incident on the liquid crystal array 113 whereupon, depending on the voltage applied to each liquid crystal pixel, the plane of polarization is either rotated or not. The front absorptive polarizer 115 transmits the light emanating from the liquid crystal array 113 in proportion to the degree of polarization rotation imparted by the liquid crystal pixels, finally reaching the viewer 121.

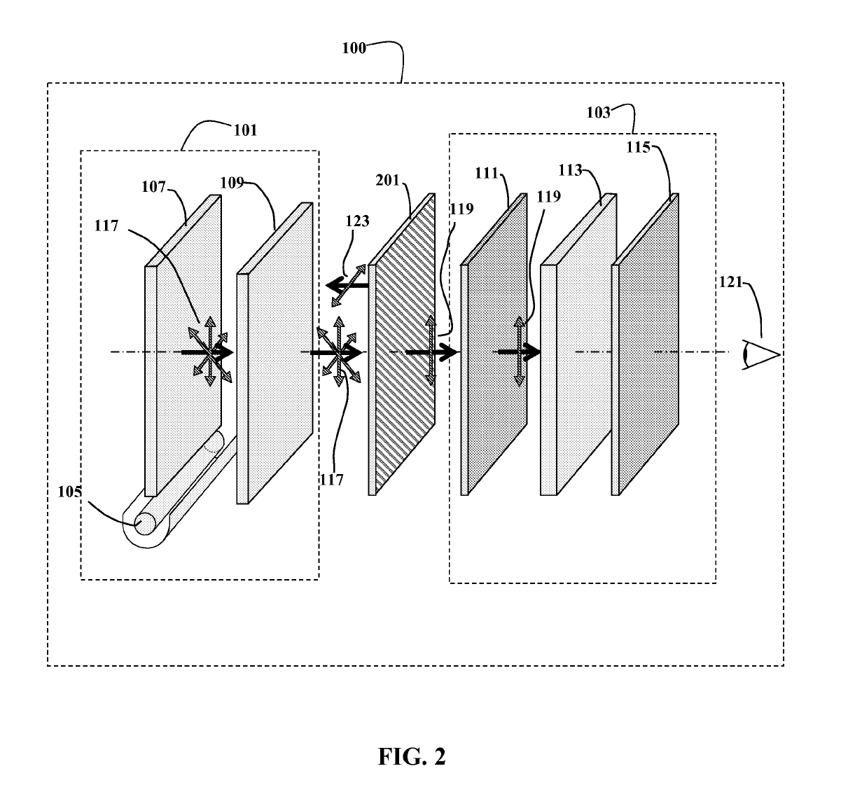

As seen in FIG. 2, an enhancement of the brightness of an LCD as perceived by a viewer 121 can be obtained by an innovation referred to as polarization recycling. Inserting a reflective polarizer 201 between the backlight assembly 101 and the liquid crystal panel assembly 103 causes the light with a plane of polarization that would normally be absorbed 123 by the rear absorptive polarizer 111 to be reflected back towards the backlight assembly 101. Light with the desired plane of polarization 119 is transmitted by the polarization recycling film 201 as well as the rear absorptive polarizer 111 before going through the process described above.

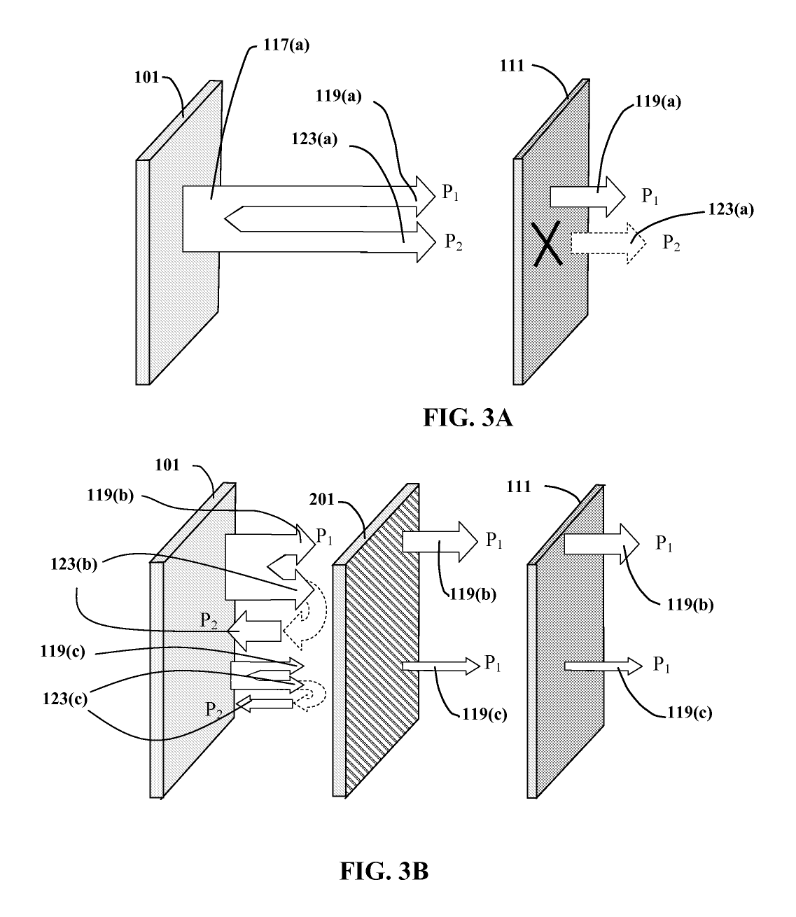

The details of polarization recycling can be described more easily with the aid of FIGS. 3A-3B. To understand the principle of polarization recycling, FIG. 3A and FIG. 3B compare two scenarios. FIG. 3A illustrates a scenario without polarization recycling and FIG. 3B illustrates a scenario with polarization recycling. Considering the scenario without polarization recycling first, the backlight assembly 101 generates unpolarized light 117(a), which can be represented as equal amounts of two orthogonal planes of polarization 119(a) and 123(a). As seen in FIG. 3A, the rear absorptive polarizer 111, usually positioned between the liquid crystal array 113 and the backlight assembly 101, transmits one plane of polarization 119(a), desirably with little attenuation, while substantially absorbing the orthogonal plane of polarization 123(a). (The ratio of intensity of the transmitted plane of polarization 119(a) to intensity of the absorbed plane of polarization 123(a) is referred to as the contrast ratio of the polarizer 111.) If the rear absorptive polarizer 111 has a high transmission of light with the preferred plane of polarization 119(a), then the intensity of the light available for modulation by the liquid crystal array is just the intensity of the transmitted plane of polarization 119(a).

In the second scenario, illustrated in FIG. 3B, polarization recycling is achieved by inserting a reflective polarizer 201 between the backlight assembly 101 and the rear absorptive polarizer 111. As before the backlight assembly 101 produces essentially equal quantities of two orthogonal planes of polarization 119(b) and 123(b). The reflective polarizer transmits light of one plane of polarization 119(b) and importantly reflects the light of the orthogonal plane of polarization 123(b) back towards the backlight assembly 101. The light of the reflected plane of polarization 123(b) undergoes multiple scattering events in the backlight assembly 101 and because the backlight assembly 101 has low absorption, the reflected light 123(b) reemerges towards the viewer as unpolarized or partially unpolarized light with essentially equal quantities of two orthogonal planes of polarization 119(c) and 123(c). A fraction of the reemerging light that is polarized parallel to the plane of high transmission 119(c) of the reflective polarizer 201 will be transmitted and the remainder 123(c) reflected back again to the backlight assembly 101 whereupon the process repeats. Upon arriving at the absorptive polarizer 111, light of the correct polarization 119(b) and 119(c) are transmitted through. The net result is that in the case of polarization recycling, the sum of the intensity of the components 119(b) and 119(c), and subsequent iterations, is greater than the intensity without polarization recycling 119(a).

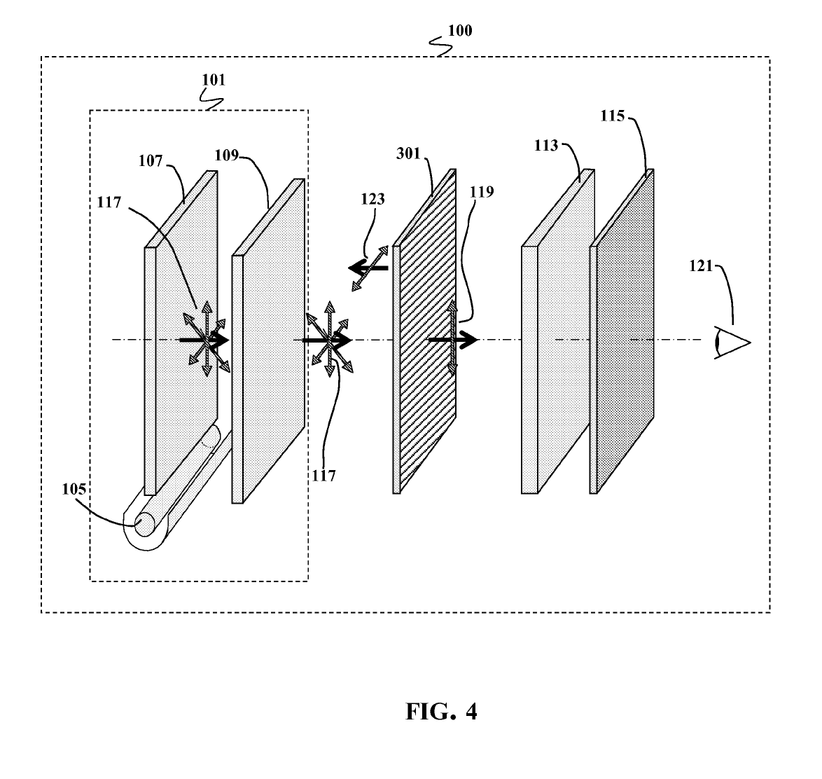

FIG. 4 illustrates a further improvement of the brightness enhancement due to polarization recycling wherein a high contrast wire grid polarizer 301 replaces both the reflective polarizer 201 and the rear absorptive polarizer 111 shown in FIG. 2. In the configuration illustrated in FIG. 4, both polarization recycling and high contrast polarization may be accomplished by a single film thereby simplifying the construction and lowering the cost of a LCD. The functionality of the wire grid polarizer 301 will be described in further detail below.

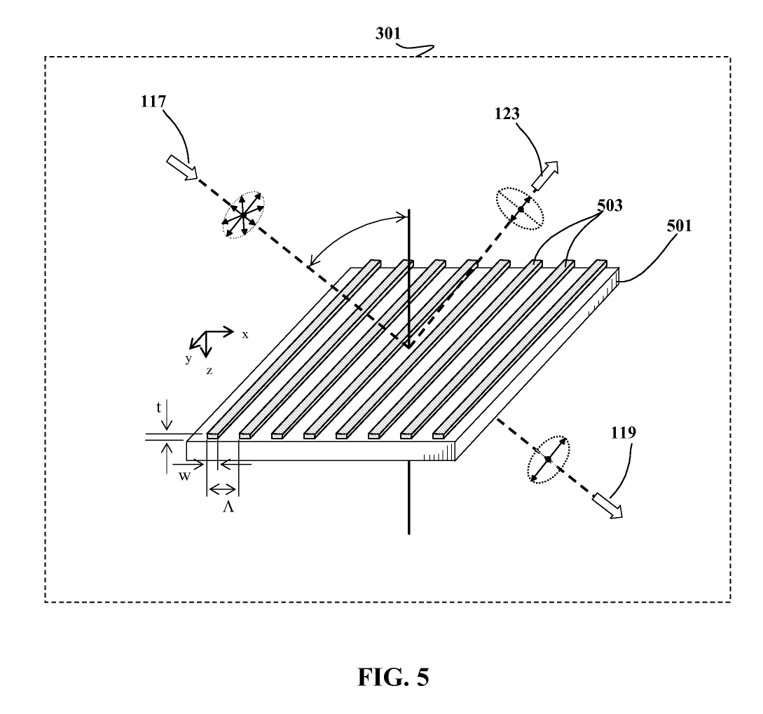

A wire grid polarizer 301, shown schematically in FIG. 5, generally comprises an array of electrically conductive, (e.g., metallic) sub-wavelength parallel lines 503 with a period, A, that is less than ⅓ of the wavelength of the light to be polarized, situated on a substrate 501. The conductive lines 503 may be made of a metal, such as aluminum. Alternatively, the lines 503 may be made of other electrically conductive materials, e.g., conductive polymers or highly doped semiconductors. For visible light (450-750 nm), the period A would be about 150 nm or less in order to efficiently polarize the shortest wavelengths of the spectrum. Unpolarized incident electromagnetic waves 117, which have a component of their electric field aligned parallel to the conductive lines 503 (s-polarization) of the wire grid polarizer 123 are substantially reflected. Waves with electric fields perpendicular to the direction of the conductive lines 119 (p-polarization) are able to travel through the grid with only a small reduction in intensity, i.e., high transmission. Since electric field components parallel to the wires 123 are primarily reflected, the transmitted wave 119 has an electric field substantially only in the direction perpendicular to the wires, and is thus linearly polarized (p-polarization).

The key optical performance metrics for any polarizer technology, including wire grid polarizers, are contrast and transmission. Contrast, as described above, is the ratio of the transmitted intensity of p-polarization divided by the transmitted intensity of s-polarization (also known as the extinction ratio). The transmission of a polarizer is defined as the percentage of incident unpolarized light that is transmitted by the polarizer. For high contrast polarizers, the light transmitted by the polarizer is practically given by the ratio of the intensity of p-polarized light transmitted to the intensity of the incident unpolarized light.

In wire grid polarizers, as with all other types of polarizers, there is an inverse relation or trade-off between the contrast (extinction) ratio and light transmittance. As noted in several prior art descriptions, for example Hansen et al describes in U.S. Pat. No. 6,243,199, which is incorporated herein by reference, that for a given metal line periodicity (pitch) wire grid polarizers with wider metal lines have higher contrast but their transmission is sacrificed, while narrower metal lines have lower contrast but have higher transmission. Hansen's discussion also shows that for a given periodicity, taller metal lines have higher contrast but their transmission is lower. Additional wire grid polarizer design tradeoffs specifically addressing the application of polarization recycling are described by Mi et al in US Patent Application Publication 20060061862, which is incorporated herein by reference. This prior art demonstrates that wire grid polarizers can be engineered to have the optimum transmission and contrast ratio for a particular application such as polarization recycling.

Currently available wire grid polarizers, for example those made by Moxtek Inc. of Orem Utah are fabricated on rigid glass substrates using conventional semiconductor processes such as metal deposition, photolithographic patterning and etching; preferably reactive ion etching (see Garvin et al U.S. Pat. No. 4,409,944, which is incorporated herein by reference). With this approach, which is not unique to Moxtek, the high precision of semiconductor based processing, enables tailoring the height, width, and duty cycle of the metal lines over a substantial range. Thus, this semiconductor type processing based approach is well suited to optimize the contrast and transmission of wire grid polarizers for applications such as polarization recycling.

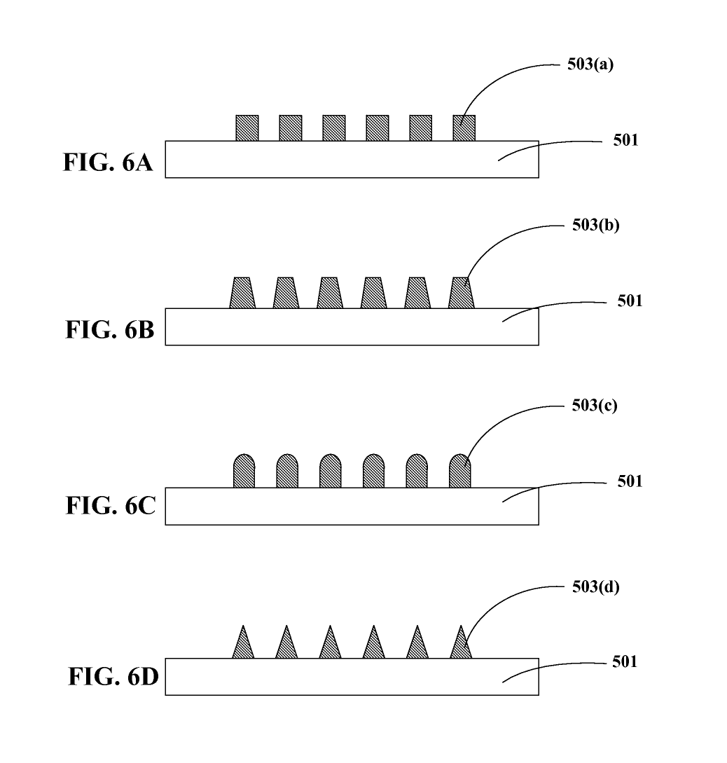

Prior art attempts to engineer the optical performance of wire grid polarizers have also included modifications to the traditional rectangular cross-sectional shape of the metal lines. FIG. 6A illustrates the traditional rectangular cross-sectional shape of the metal lines 503(a). In U.S. Pat. Nos. 5,748,368 and 6,714,350 both of which are incorporated herein by reference, advantages are claimed for the trapezoidal cross-sectional shape of the metal lines 503(b) illustrated in FIG. 6B. U.S. Pat. Nos. 6,243,199 and 6,844,971 (both of which are incorporated herein by reference) describe advantages of a semicircular cross-sectional shape of the metal lines 503(c) illustrated in FIG. 6C. The most impressive optical performance improvements over the traditional rectangular cross-sectional shape of the metal lines were realized with a triangular cross-sectional shape of the metal lines 503(d) illustrated in FIG. 6D (see U.S. Pat. No. 7,046,442, which is incorporated herein by reference).

However, due to limits on the size of substrates that can be processed with semiconductor type processing equipment, this approach to fabricating wire grid polarizers cannot handle substrates larger than 300 mm (12 in.). This limitation puts a strict limit on the size of the wire grid polarizers that can be made in this manner to less than that needed for larger area TVs, e.g., 54″ diagonal. Larger processing equipment could be made but this presents a number of further issues that have not yet been researched. In addition, the cost to manufacture wire grid polarizers with this ultra precision semiconductor type processing equipment is too high to be competitive with the large area (absorptive) film polarizers that dominate the LCD polarizer industry.

An alternative method that does enable the fabrication of wire grid polarizers at low cost and large area consists of an embossing process followed by an oblique angle deposition of metal (see for example US Patent Application Publications 20060159958 and 20060118514, both of which are incorporated herein by reference, which contain only cursory descriptions of the embossed shapes and no description of the angular flux distribution of the oblique angle metallization process).

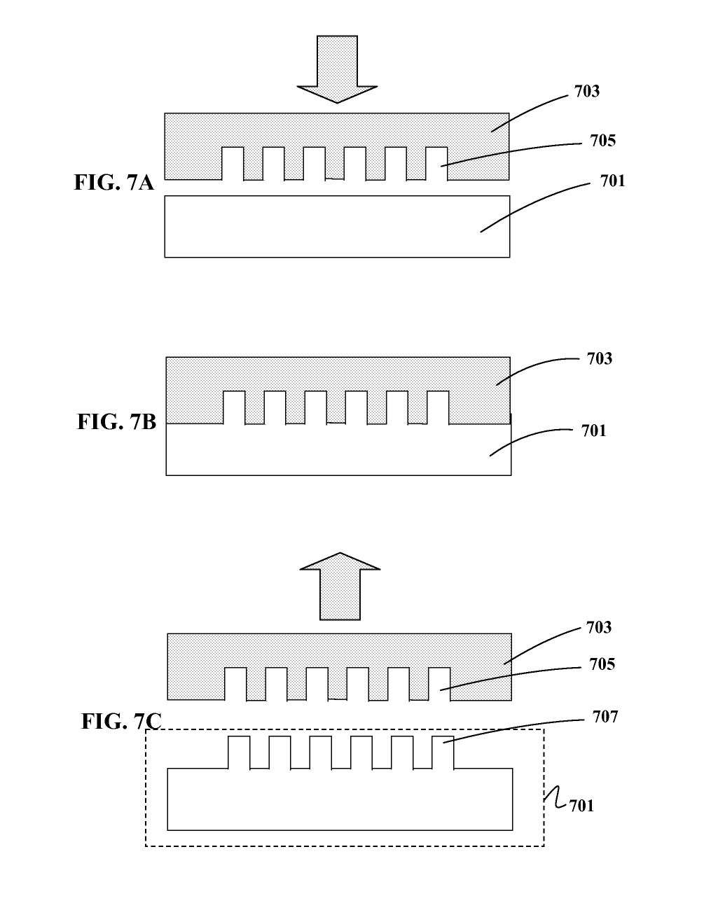

FIGS. 7A-7C schematically depicts the embossing process. As shown in FIG. 7A-FIG. 7B, an embossing tool 703 containing the negative of the desired shape 705 is pressed into a polymer substrate 701 to form the desired shape 707. Alternatively, the embossing could be done to a coating applied to the upper surface of the polymer substrate 701. This alternative is not shown. Either a thermal embossing or a UV curing process could be used. After the embossing (FIG. 7C), the embossing tool 703 is released from the polymer substrate 701 leaving behind the desired surface shapes 707 on the polymer substrate 701.

Preferred polymer substrates are polycarbonate, triacetate cellulose, and polyethylene teraphthalate (PET) with a thickness ranging from 50 μm to 300 μm. The preferred periodicity of the nanoembossed shapes range from 100 nm to 150 nm. The preferred height of the embossed shapes range from 70 nm to 150 nm.

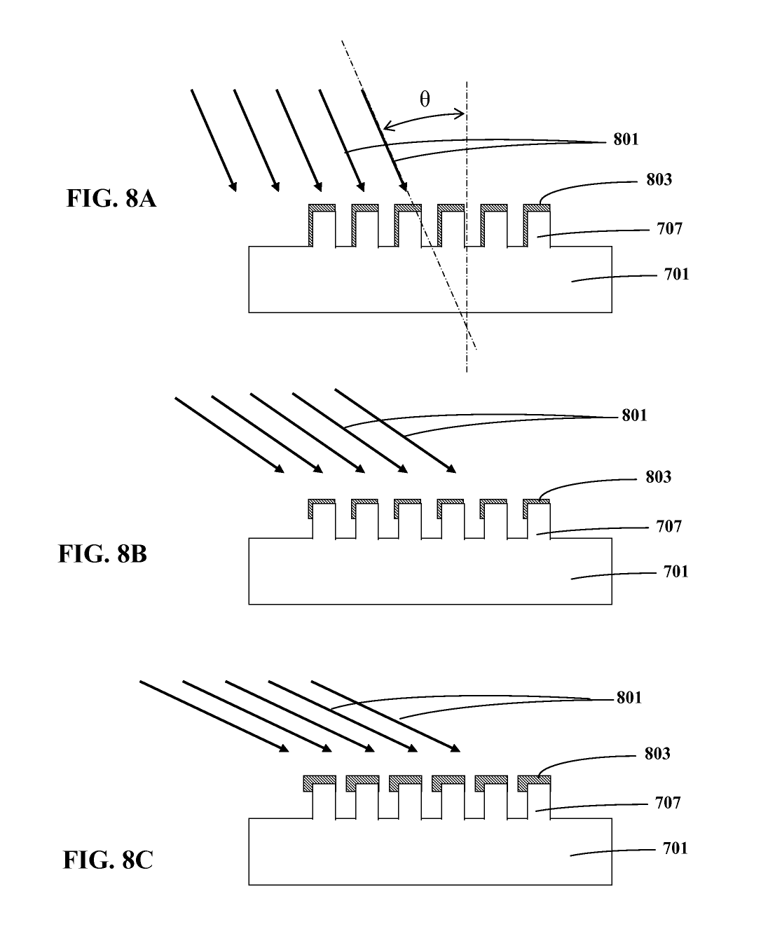

Subsequent to forming the desired ridge and valley features 707 on the surface of the polymer substrate 701, an oblique deposition of metal is used to fabricate an array of parallel metal lines 803, which is schematically illustrated in FIGS. 8A-8C. A vacuum deposition source of metal (not shown for simplicity), that is offset from the normal to the substrate, produces a deposition flux 801 incident on the substrate 701 at an angle θ to the substrate normal. In the ballistic transport regime of deposition, the trajectories of the metal ad-atoms prevent metal from depositing on surfaces that are shadowed by the surface topography. In this manner, metal lines 803 are formed on the surface topography features 707. FIG. 8A, FIG. 8B, and FIG. 8C illustrate the oblique deposition of electrically conductive material, e.g., metal, at increasing angles of incidence. The increase in the angle of incidence θ of the metal flux 801 onto the substrate 701 results in modified cross-sectional shapes of the metal lines 803. For this reason, most prior art cites preferred ranges for the angle of incidence however, no known prior art discusses the angular flux distribution or the importance of this parameter.

There are several advantages to this nanoembossing and oblique metal deposition approach: (a) embossing into a flexible polymer substrate provides a much lower low cost method for producing nanoscale ridge and valley structures than a photolithographic patterning and etching approach; (b) oblique evaporation of a suitable metal such as aluminum, silver, or an alloy, to create the wire grid polarizer's metallic lines is a much lower low cost method for forming the conductive lines than photolithographic patterning and etching; (c) both embossing and oblique metal deposition can be accomplished using a continuous roll to roll process that is one of the lowest cost manufacturing approaches available; and (d) the minimal number of processing steps of this approach, nanoembossing followed by oblique metal deposition, and their simplicity, enables high manufacturing yields which materially reduces overall manufacturing costs.

Embossing has been shown to be capable of ultra high fidelity replication of features with resolutions smaller than 5 nm. The ridge and valley feature size of typical wire grid polarizers needed for LCD applications is in the range of 100-150 nm. Thus, the cross-sectional shape of the ridge and valley features embossed into the polymer substrate can be engineered into the embossing tool to provide a wide range of ridge and valley feature shapes.

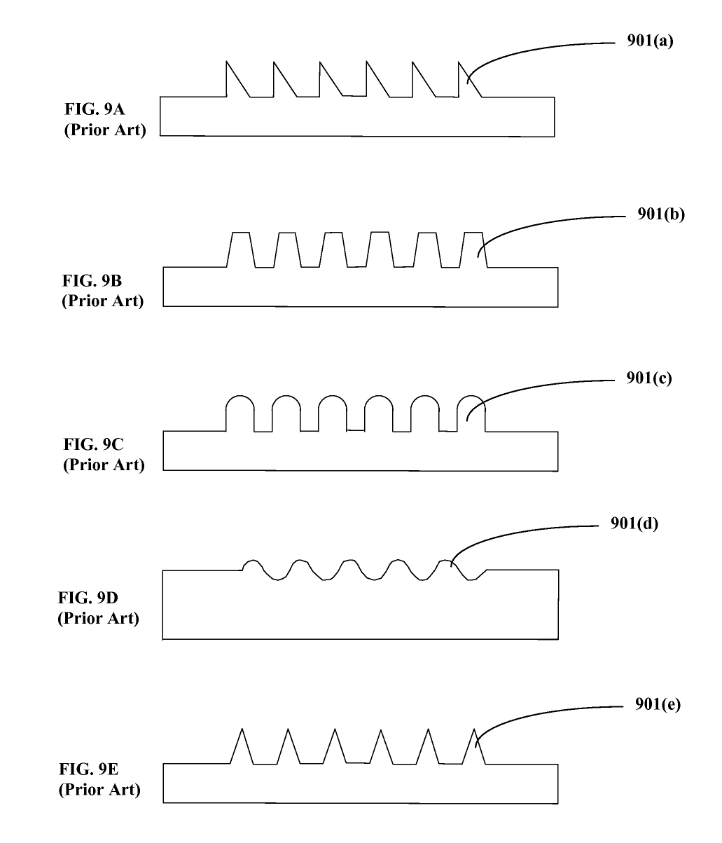

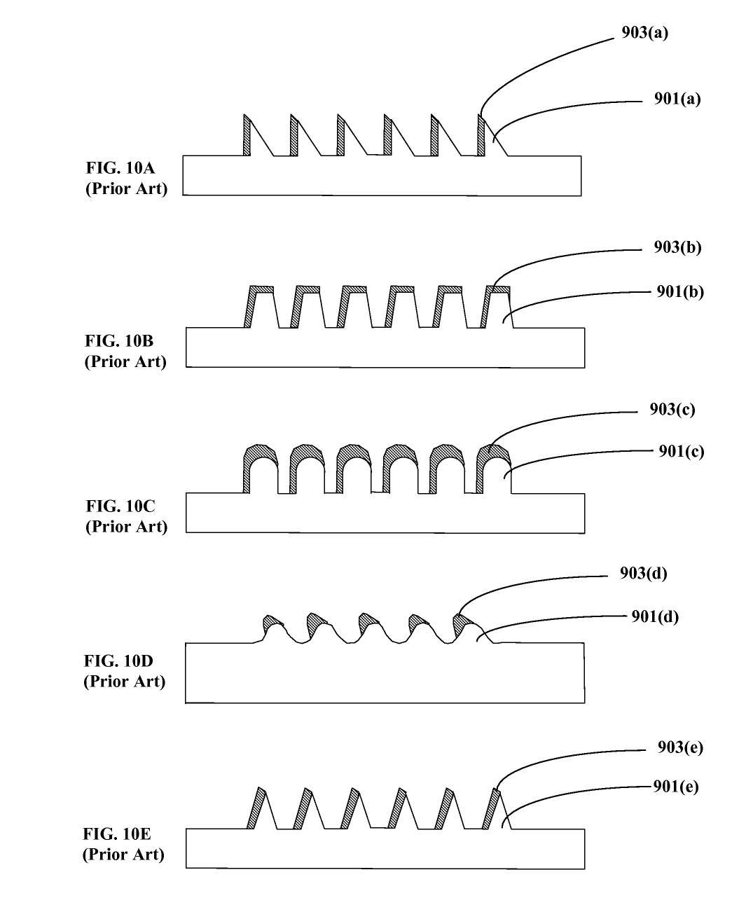

Prior art in the nanoembossing and oblique deposition approach to fabricating wire grid polarizers has pursued a number of different embossed shapes beyond the traditional rectangular cross-sectional shape (see FIGS. 9A-9E and FIGS. 10A-10E). While the nanoembossed nanoscale ridge and valley structures of this prior art have cross-sectional shapes similar to those developed for the photolithography and etching approach described earlier in reference to FIG. 6, it is primarily the cross-sectional shape of the metal lines, not the shape of the nanoembossed features per se, that determine the optical properties of the wire grid polarizer.

Generally, the same electromagnetic equations that dictate contrast and transmission of a metal line wire grid polarizer are the same for both the photolithography and etching approach and the nanoembossing and oblique deposition approach. Shorter pitch produces higher contrast and duty cycle. As used herein, duty cycle is defined as the fractional percentage of each line and space pair that is occupied by the electrically conductive material. When the total lateral extent of the metal cross-sectional shape occupies a large fraction of the pitch (i.e., high duty cycle), the optical contrast is increased and the transmission is decreased. Conversely, when the total lateral extent of the metal cross-sectional shape occupies a smaller fraction of the pitch (i.e., lower duty cycle), there is more open “gap” space resulting in higher transmission but decreased contrast.

A saw tooth cross-sectional ridge and valley shape 901(a) is illustrated in FIG. 9A and was disclosed by Bird in U.S. Pat. No. 3,046,839. The corresponding metal line cross-section 903(a) resulting from oblique evaporation onto this saw tooth embossed shape 901(a) is illustrated in FIG. 10A. However, no optical performance results or specific benefits of this cross-sectional metal line shape 903(a) to either contrast or transmission were cited. This prior art claims a method to fabricate a wire grid polarizer of unknown optical performance.

An embossed trapezoidal cross-sectional ridge and valley shape 901(b) is illustrated in FIG. 9B and was described by Sriram in U.S. Pat. No. 4,512,638 and by Nilsen in US Patent Application Publication 20020044351, both of which are incorporated herein by reference. The corresponding cross-sectional shape of the metal line 903(b) is illustrated in FIG. 10B. Again, no optical performance results or specific benefits of this cross-sectional metal line shape 903(b) to either contrast or transmission were cited.

An embossed semi-circular cross-sectional shape 901(c) is illustrated in FIG. 9C and was described by Yamaki in US Patent Application Publication 20070087549, which is incorporated herein by reference. Other nanoembossed cross-sectional shapes are also discussed in Yamaki. The cross-sectional shape of the metal line 903(c) corresponding to the semi-circular embossed shape 901(c) is illustrated in FIG. 10C. The optical performance results cited for this cross-sectional metal line shape 903(c) are significantly inferior to the performance of the traditional rectangular line shape wire grid polarizer.

An embossed sinusoidal cross-sectional shape 901(d) is illustrated in FIG. 9D and was described by Nilsen in US Patent Application Publication 20020044351 and by Yamaki in US Patent Application Publication 20070087549. The cross-sectional shape of the metal line 903(d) corresponding to the sinusoidal embossed shape 901(d) is illustrated in FIG. 10D. The optical performance results cited for this cross-sectional metal line shape 903(d) are inferior to the performance of the traditional rectangular line shape wire grid polarizer. Like the other prior art, this prior art claims a method of fabricating wire grid polarizers with performance inferior to that of a traditional rectangular cross-section metal line wire grid polarizer.

A triangular embossed shape 901(e) of the type shown in FIG. 9E has been cited in several prior art attempts, most notably, U.S. Pat. No. 4,512,638, US Application Publication 20020044351 and US Application Publication 20060159958. The cross-sectional shape of the metal line 903(e) corresponding to the triangular embossed shape 901(e) is illustrated in FIG. 10E. As described earlier, the highest wire grid polarizer optical performance has been obtained with metal lines with a triangular cross-sectional shape. However, as noted earlier, it is the shape of the metal line and not the shape of the nanoembossed feature that dictates the contrast and transmission of a wire grid polarizer. No optical performance results or specific optical benefits of the embossed triangular cross-sectional shape to either contrast or transmission were cited.

To achieve a preferred metal cross-sectional shape with a combination of nanoembossing and oblique evaporation approach requires a closer coordination of both the shape of the nanoembossed features and the oblique metal deposition process. A thorough understanding of the details of the oblique deposition process is required to enable the design of a nanoembossed shape such that the combination of the deposition process together with the shape of the nanoembossed features will result in the preferred cross-sectional shape of the resulting metal lines.

There are a number of techniques that have been developed for the physical vapor deposition of metals, notably sputtering and vacuum evaporation. Each of these methods produces a broad angular flux of material to be deposited onto a substrate. The angular trajectories of the deposition material exiting the surface of the source depend on a number of factors including the pressure during deposition and the proximity of the source to the target substrate. The different flux distributions result in different coating thickness distributions when deposited on substrates with surface topographies.

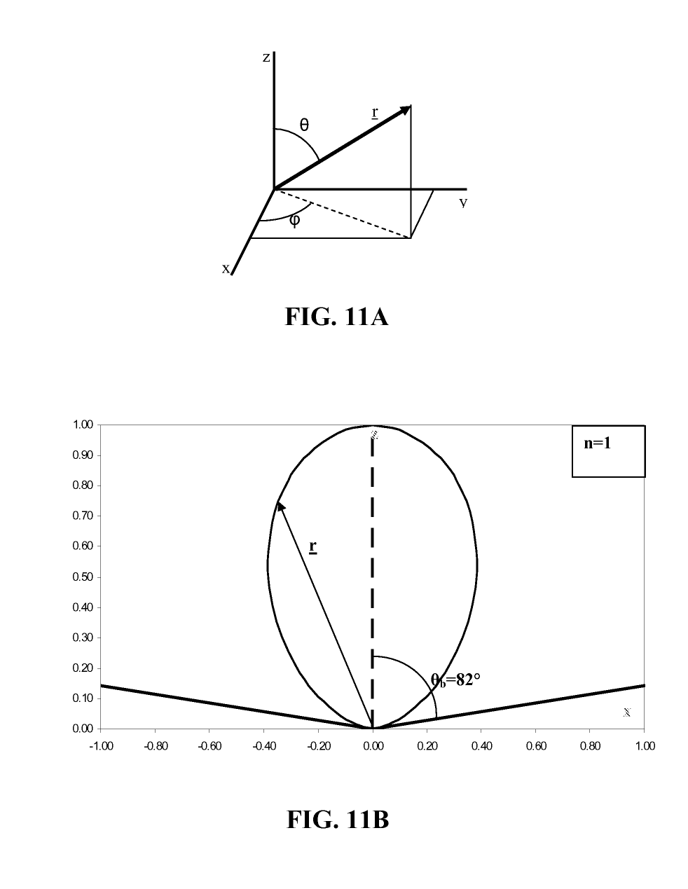

Practical physical vapor deposition sources are usually characterized by flux distributions typically referred to as a cosine distribution (see Equation 1 below). Particles emitted from each point in the source have a trajectory r=xi+yj+zk, where the (θ, φ) coordinate system is indicated in FIG. 11A where:

x=sin(θ)cos(φ)

y=sin(θ)cos(θ)

z=cos(θ)

and

cos(θ)=P^{1/(n+1)};0≦P≦1,n≧0

φ=2πp;0≦p≦1

A 2-dimensional plot of this distribution for n=1, φ=constant, is illustrated in FIG. 11B. Each point on the surface of the source emits particles in the direction r with a probability proportional to the cosine function shown. Thus, the cosine function shown can be interpreted as indicating the material flux density in a particular direction. The flux density emerging from each point on the surface of the source is highest in the surface normal direction (along the z-axis) and falls off as the angle from the surface normal increases.

For deposition conditions where the mean free path of the material being deposited is long compared to the physical distance from the source to the substrate, ballistic trajectories can be used to calculate the ad-atom arrival patterns and hence the deposition profiles on surfaces with topography.

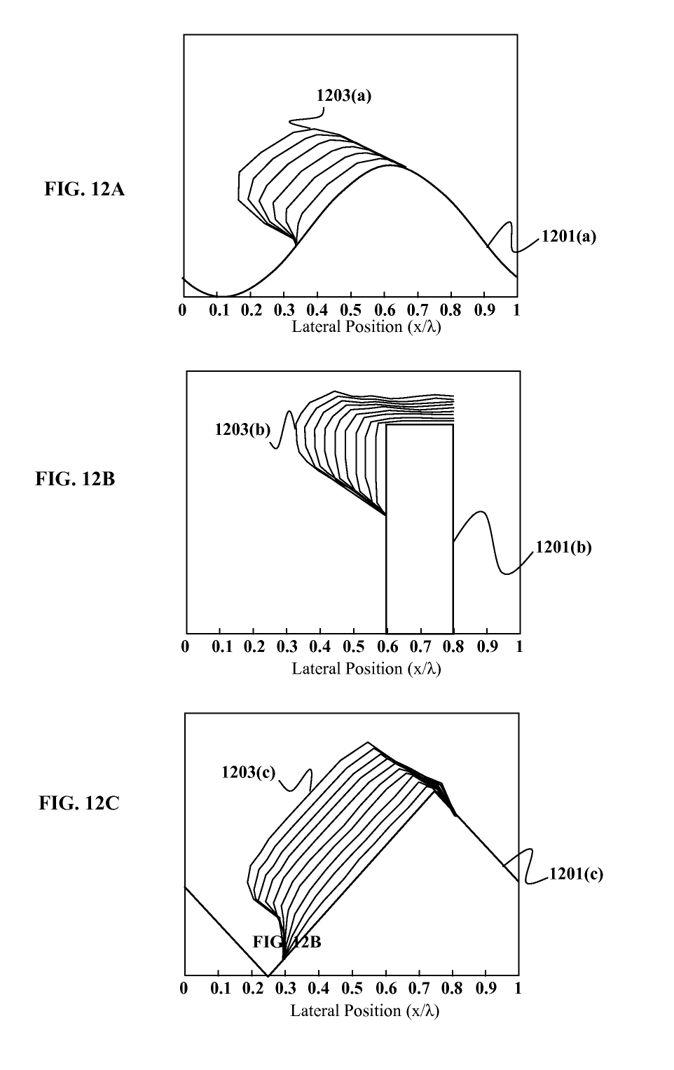

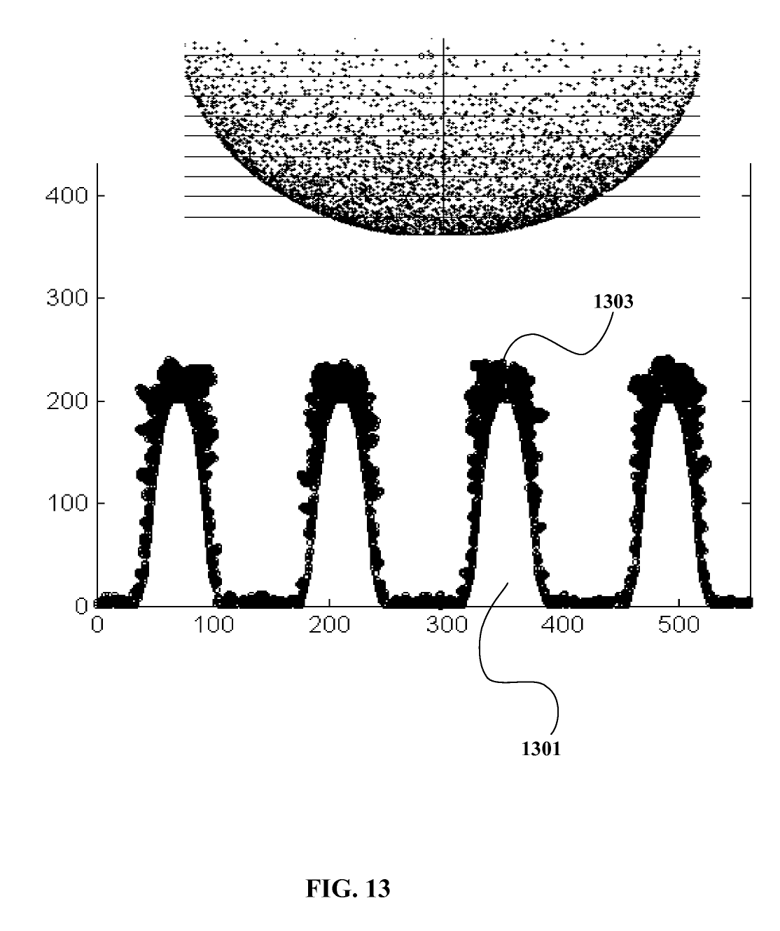

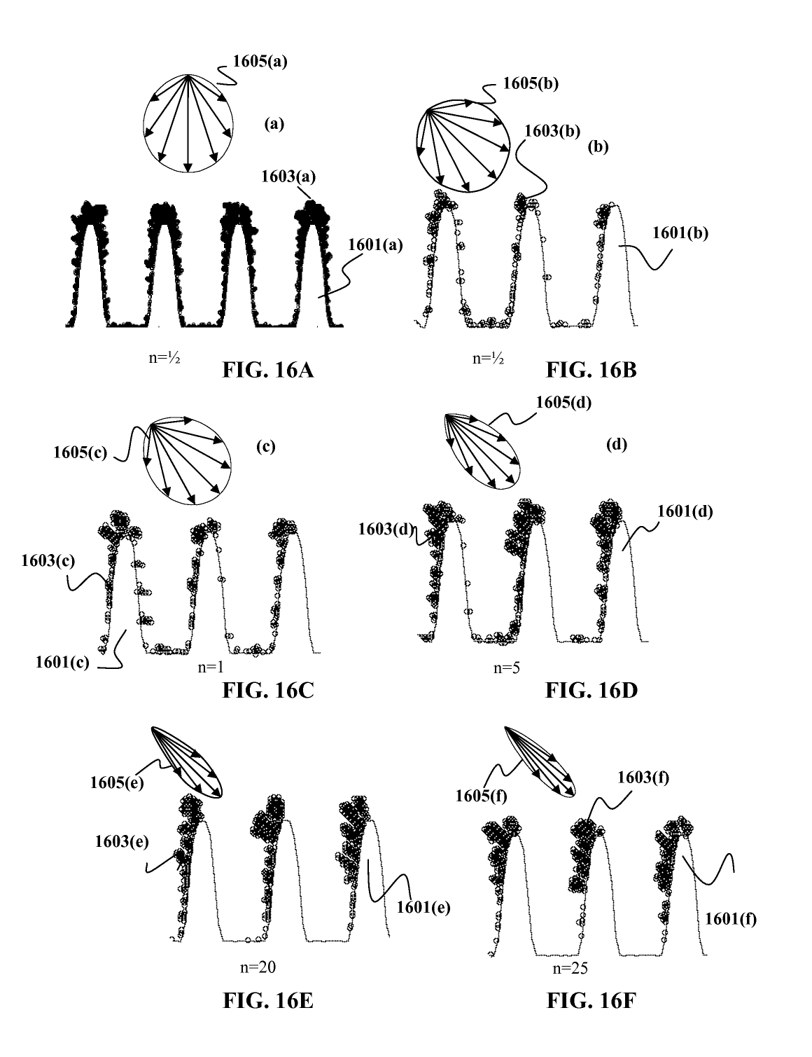

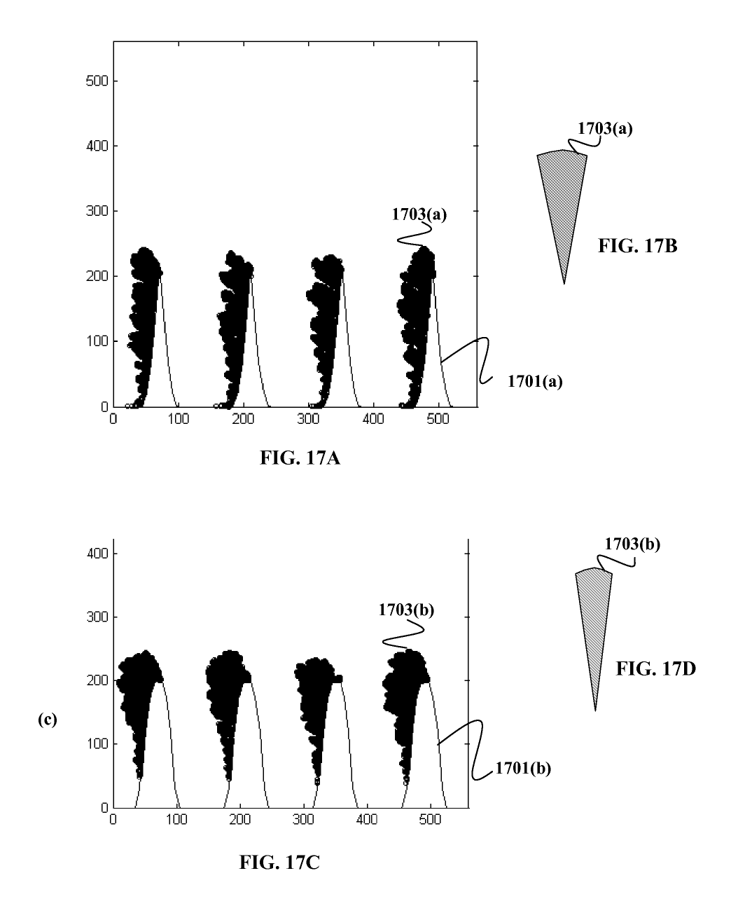

The detailed thickness profile of metal deposited onto topographic features depends on both the angular distribution of the metal flux arriving at the substrate and the shape of the surface topography. Example results of detailed Monte Carlo computer simulations of various source flux distributions that illustrate this interdependency are shown in FIG. 12A-12C, FIG. 13, FIG. 16A-16F, and FIG. 17A-17C

Monte Carlo computer simulations of the oblique deposition of metal on several prior art surface feature shapes are shown in FIGS. 12A-12C. A sine wave shaped surface feature 1201(a) is shown in FIG. 12A. Oblique deposition of metal results in a laterally growing metal line 1203(a), substantially growing towards the deposition source. Additional Monte Carlo simulations wherein the angle of incidence of the deposition was changed show that the cross-sectional shape of the metal line is slightly altered, but the general behavior remained the same. The large lateral extent of this metal line profile 1203(a) narrows the gap between adjacent lines and results in high duty cycle wire grid polarizer with relatively low transmission. Reducing the thickness of the metal deposition to achieve higher wire grid polarizer transmission also reduces the height of the metal lines thereby significantly reducing the contrast. Thus, with this surface feature shape 1201(a) the wire grid polarizer performance will be unacceptably poor.

The Monte Carlo simulations of oblique metal deposition onto a rectangular cross-sectional shape 1201(b) is shown in FIG. 12B. FIG. 12B shows a lateral growth 1203(b) behavior similar to that found for the sinusoidal surface shape 1201(a). This lateral growth 1203(b) phenomena results in a poorly performing wire grid polarizer for the same reasons cited above.

The results of modeling a triangular surface shape 1201(c) are shown in FIG. 12C. While the lateral growth of the metal deposit 1203(c) with this surface shape 1201(c) is less severe than with either the sinusoidal 1201(a) or rectangular shapes 1201(b), it remains appreciable. The shape of the metal line is largely rectangular but tilted at an angle roughly parallel to the face of the triangular shape; this tilting effectively increases the duty cycle beyond that of a non-tilted rectangle. Wire grid polarizers made with oblique deposition onto triangular shapes 1201(c) have optical performance superior to the above shapes but remain inferior to the tradition rectangular metal line cross-section shape.

The Monte Carlo simulations above detail the metal line cross-sectional profiles resulting from oblique angle deposition onto known prior art shapes. The optical performance of these examples is inferior to the optical performance of wire grid polarizers made with traditional rectangular metal line cross-sectional profiles. The other principle parameter of oblique angle deposition, angular flux distribution is now discussed.

FIG. 13 is a Monte Carlo simulation of the metal deposition profile resulting from the source flux distribution shown in the inset with the topological shape 1301 indicated in the main plot. The source flux distribution shown in FIG. 13 is that of a typical deposition source (i.e., an n=1 cosine distribution) incident along the surface normal direction to the substrate 1301. In this view, the density of dots corresponds to the deposition flux in any given direction. This typical source flux profile produces the metal line profile 1303 shown where black dots are used to represent clusters of metal deposition 1303 that accumulate on the surface topography features 1301 shown.

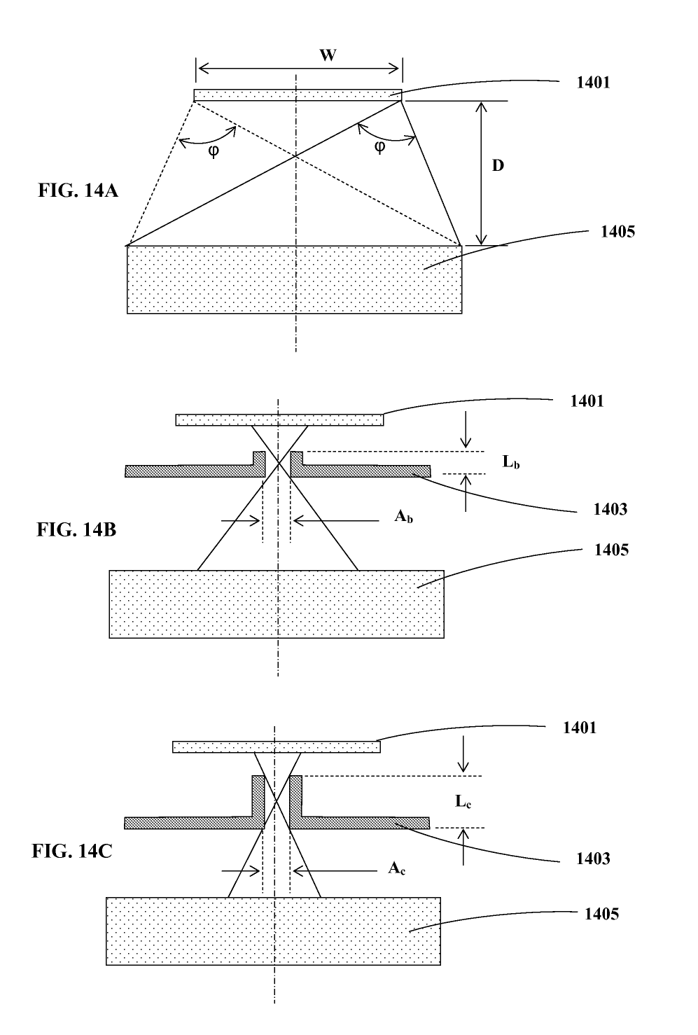

As illustrated in FIGS. 14A-14C, introducing baffles (as used herein, a mask that limits the angular range of flux incident on the substrate) 1403 between the deposition source 1401 and the substrate 1405 is known to modify the source flux distribution (for example see U.S. Pat. No. 4,043,647, which is incorporated herein by reference). An unbaffled source geometry is schematically illustrated in FIG. 14A. The deposition source 1401 is positioned a distance D away from the substrate target 1405 and centered over the substrate target 1405. At each point along the lateral extent W of the source 1401 a cosine distribution of flux is emerging. Thus, the substrate will collect deposit over all angles from −φ to +φ.

As shown in FIG. 14B, introducing a baffle 1403 between the source 1401 and the substrate 1405 will limit the angular range of flux incident on the substrate 1405. The angular range limits of a baffle 1403 are determined by the aspect ratio of the baffle 1403. The aspect ratio is the ratio between the baffles's 1403 height L and its aperture A. As can be observed by comparing FIG. 14B and FIG. 14C, increasing the aspect ratio of the baffle 1403 narrows the range of angular flux incident on the substrate 1405.

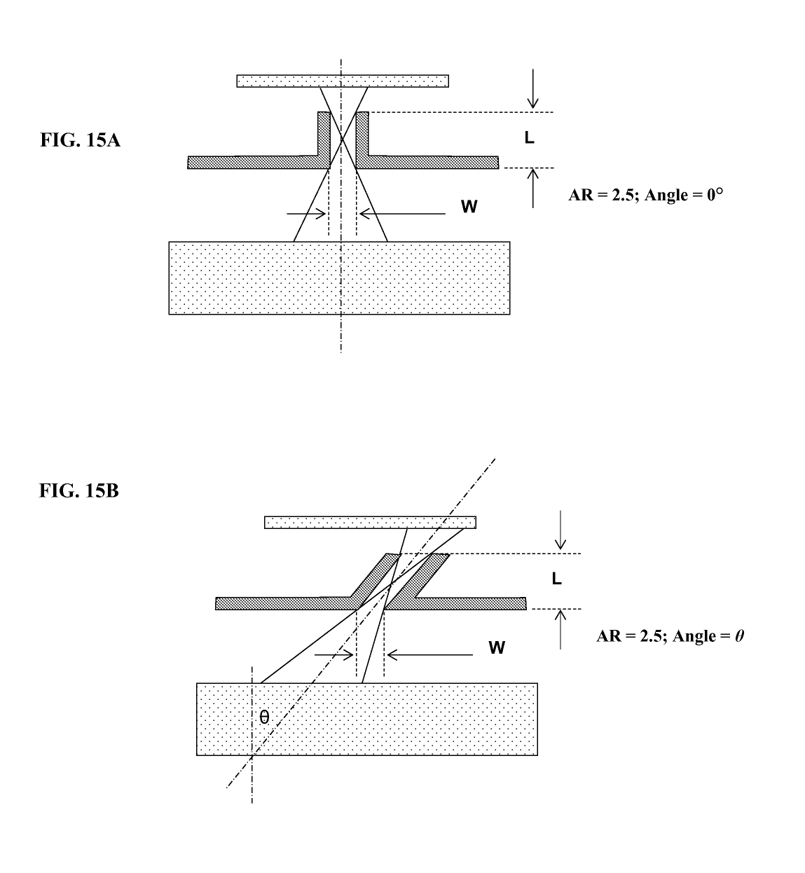

As shown in FIGS. 15A-15B, the principle of baffling to control the angular flux distribution of a deposition source 1401 can be extended to oblique deposition (see FIG. 15B). Tilting the baffles 1403 relative to the perpendicular between the source 1401 and the substrate 1405 results in an oblique angle bias to the source flux distribution.

A series of additional Monte Carlo simulations of metal deposition onto one preferred surface shape are illustrated in FIGS. 16A-16F. This series illustrates the effects of angle of incidence and angular flux distributions of metal deposited onto one preferred surface feature shape.

FIG. 16A shows the metal line cross-sectional shape 1603(a) obtained on one preferred surface feature shape 1601(a) with an unbaffled source flux distribution incident at normal incidence 1605(a). The reason this is one of the preferred surface shapes will become apparent later. This unbaffled source distribution at normal incidence 1605(a) to the substrate results in a significant amount of metal deposited on all surfaces, on the sidewalls, along the bottom of the valley between the ridges and on top of the ridges. This cross-sectional metal line 1603(a) shape produces barely perceptible optical behavior of a wire grid polarizer. Thus, while this is a shape that will be shown later to be capable of excellent optical performance, with this deposition geometry the optical performance is unacceptable low.

The metal line profile 1603(b) resulting from orienting an unbaffled source at an oblique angle)(45°) 1605(b) is shown in FIG. 16B. The self-shadowing effect of oblique angle deposition onto surface topographic features 1601(b) is evident in this metal line cross-section. However, with this unbaffled source, thin layers of metal are present on the leeward side of the preferred surface features 1601(b) and significant amounts of metal accumulate along the bottom of the valley between the ridges, which adversely impact the optical performance. The optical performance of wire grid polarizers with this cross-sectional metal line profile 1603(b) is still very poor.

Narrowing the angular flux distribution by the use of baffles with an aspect ratio of 1 oriented at this same 45° oblique angle 1605(c) results in the metal line profile 1603(c) shown in FIG. 16C. Less metal is deposited on the leeward side of the preferred shapes 1601(c) but a significant amount of metal accumulates along the bottom of the valleys. The optical performance of wire grid polarizers with this cross-sectional metal line 1603(c) profile is somewhat better than the previous case, but remain very poor.

Further narrowing the angular flux distribution by the use of baffles with an aspect ratio of 2 oriented at the same 45° oblique angle 1605(d) on a preferred surface feature shape 1601(d) results in the metal line profile 1603(d) shown in FIG. 16D. This geometry results in a thickening of the metal deposited near the top of the ridges and a further reduction in the metal thickness on the leeward side of the ridges. However, there is still a significant accumulation of metal along the bottom of the ridges, which diminishes optical transmission.

Yet further narrowing the angular flux distribution by the use of baffles with an aspect ration of 3 oriented at this same 45° oblique angle 1605(e) on a preferred surface feature shape 1601(e) results in the metal line profile 1603(e) shown in FIG. 16E. The accumulation of metal along the tops of the ridges begins to create a metal line profile 1603(e) that is a narrow triangular shape that is wider proximate the top and narrower proximate the bottom of the ridges. The essential absence of metal deposit along the bottom of the valley enables the optical performance of the wire grid polarizers with this cross-sectional metal line profile 1603(e) to be superior to that of a wire grid polarizer with a conventional rectangular metal line profile.

As shown in FIG. 16F, continued narrowing of the angular flux distribution by the use of baffles with an aspect ratio of 4 oriented at this same 45° oblique angle 1605(f) on a preferred surface feature shape 1601(f) results in the metal line profiles 1603(f) not significantly improved over those illustrated in FIG. 16E.

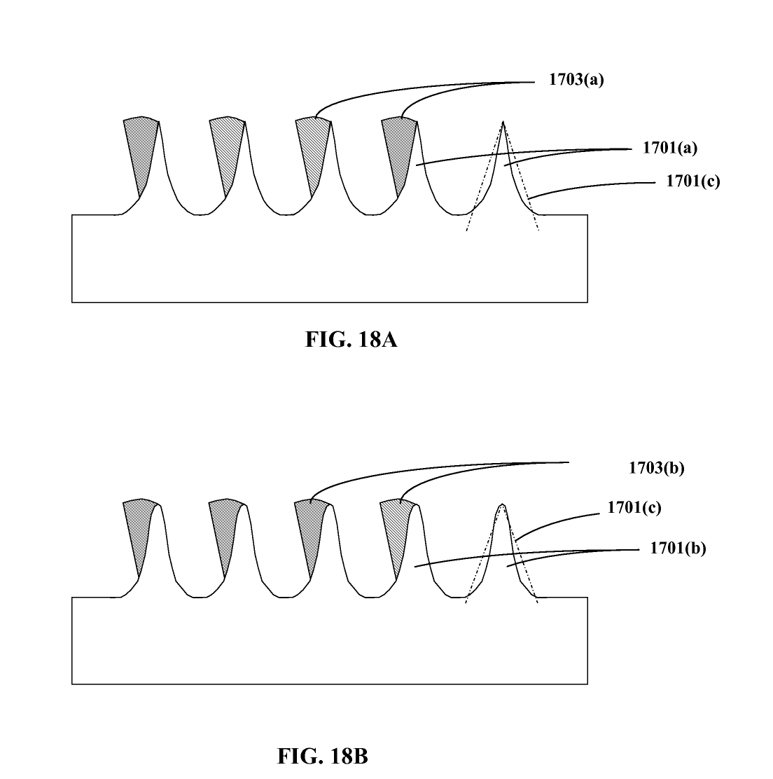

FIGS. 17A and 17C illustrate the results of more detailed Monte Carlo simulations of metal deposition onto ridges 1701(a), 1701(b) having preferred cross-sectional shapes shown more clearly in FIG. 18A and FIG. 18B respectively. In the first preferred embodiment, the sidewalls of the ridges 1701(a) shown in FIG. 18A have a slight convex curvature and the top of the ridges is peaked. This shape of the ridges 1801(a) when combined with the preferred angular source flux distribution results in the metal lines 1703(a) shown in FIG. 17A. The more detailed simulations shown in FIG. 17A enable the cross-sectional metal line profile 1703(a) to be seen to be in the roughly triangular shape indicated in FIG. 17B. In this embodiment, the profile of the metal line 1703(a) is a relatively narrow triangle with the tip pointing towards the substrate. The traditional fabrication approach of photolithography and etching is unable to fabricate triangular metal line profiles in this tip down configuration.

Detailed Monte Carlo simulations of oblique metal deposition with the preferred angular flux distribution onto the second preferred surface feature shape 1701(b) is illustrated in FIG. 17C. This second preferred shape is shown more clearly in FIG. 18B. The sidewalls of this preferred surface feature shape 1701(b) have a slight convex curvature and the top of the ridges is slightly rounded. This shape results in a metal line profile that has slightly broader metal width 1703(b) near the top than the first embodiment. The more detailed simulations shown in FIG. 17C enable the cross-sectional metal line profile 1103(b) to be seen to be approximately in the triangular profile shape indicated in FIG. 17D. Again, the traditional fabrication approach of photolithography and etching is unable to fabricate triangular metal line profiles in this tip down configuration.

Table 1 compares the optical performance of a commercial wire grid polarizer with a conventional rectangular metal line cross-sectional profile produced with a traditional photolithography and etching type process (Moxtek Inc., Orem, Utah; model #PPL03C) to the optical performance of a wire grid polarizer according to an embodiment of the present invention. The data demonstrates the improved performance of the triangular metal line cross-sectional profile obtained with combining optimized nanoembossed shapes with optimized control of the angular distribution of the flux during metal deposition. In Table 1, the periodicity of both wire grid polarizers is the same, 145 nm. The commercial wire grid polarizer is fabricated on glass (which is unsuitable for large area LCDs) while the embodiment of the present invention is made on a low cost, thin polycarbonate film, approximately 125 μm thick (which is suitable for large area LCDs). The contrast and transmission of both wire grid polarizers are measured at a wavelength of 550 nm.

TABLE 1
Optical Performance of Wire Grid Polarizer Designs

| | Transmission | Contrast |
|---|---|---|
| Conventional Rectangular Metal Line | 81% | 1060 |
| Profile* | | |
| Embodiments of this Invention** | 85% | 1072 |

*Moxtek, Inc., Orem, Utah - Model PPL03
**Agoura Sample ID^{#} A9-198

In this experiment, a sample was chosen that had essentially the same contrast as the Moxtek part but with a higher transmission which is believed to be due to the optimized shape of metal lines. The maximum achievable transmission was believed to be limited to about 87%. This was believed to be due to a roughly 4% reflection from each surface of the glass (total of ˜8%) and a small absorption of incident light by the aluminum of ˜5-6%.

Thus embodiments of the invention disclosed herein combine the use of controlled angular flux distribution during metal deposition together with specifically designed surface topographic shapes to create triangular metal line profiles that result in the optimum performance of wire grid polarizers as polarization recycling elements in large area LCDs. Specifically the wire grid polarizers fabricated with embodiments of this invention provide high transmission simultaneously with high contrast.

The substrate material that is embossed to form the desired ridge profile may be a transparent polymer material preferably polycarbonate, triacetate cellulose or PET in thicknesses ranging from 50 μm to 300 μm.

The nanoembossed surface features can be formed with either a thermal embossing process or a UV curing process. The periodicity of the surface features may be in the range of 50 nm to 200 nm; preferably in the range of 100 nm to 150 nm. The height of the embossed surface features is preferably in the range 60 nm to 160 nm. The shape of the embossed surface features is preferably narrow ridges. In one embodiment it is preferred to have a slight convex curvature near the top of the narrow ridges. In another embodiment it is preferred to have the sidewalls of the narrow ridges with a slight concave curvature.

The metal deposition can be done with either a vacuum evaporation process or a sputtering process, preferably a vacuum evaporation process. The preferred metal material is aluminum, silver, or combinations thereof. The thickness of the metal deposition may be in the range of 25 nm to 120 nm, preferably 60 nm. The oblique angle of the deposition is in the range of 35° to 55°, preferably 40°. The preferred source baffling to provide optimal angular flux distribution for depositing metal on the preferred nanoembossed shapes has an aspect ratio of 2.5 to 4.5, preferably an aspect ratio of 3.5

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.

What is claimed is:

1. A method for fabricating a wire grid polarizer comprising:
a) embossing a surface of a substrate with a mold having a plurality of grooves to form a plurality of raised ridges; and
b) depositing a metal line profile onto the plurality of raised ridges through one or more baffles oriented at an oblique angle to the normal of the substrate, such that the metal line profile is characterized by a cross-sectional width that tapers such that the metal line profile is wider proximate a vertex of the ridges than proximate a base of the ridges.

2. The method of claim 1, wherein a) includes a substrate made of a polycarbonate transparent polymer material.

3. The method of claim 1, wherein a) includes a substrate made of a triacetate cellulose transparent polymer material.

4. The method of claim 1, wherein a) includes a substrate made of a PET transparent polymer material.

5. The method of claim 1, wherein a) includes a substrate with a thickness in the range of 50 μm to 300 μm.

6. The method of claim 1, wherein a) includes embossing the surface of the substrate through a thermal embossing process.

7. The method of claim 1, wherein a) includes embossing the surface of the substrate through an ultraviolet (UV) curing process.

8. The method of claim 1, wherein a) includes a plurality of raised ridges with a periodicity in the range of 50 nm to 200 nm.

9. The method of claim 1, wherein a) includes a plurality of raised ridges with a height in the range of 60 nm to 160 nm.

10. The method of claim 1, wherein a) includes a plurality of raised ridges, wherein the ridges are narrow and have a slight convex curvature near the top of the raised ridge.

11. The method of claim 1, wherein a) includes a plurality of raised ridges, wherein the ridges are narrow and the sidewalls of the narrow ridges have a slight concave curvature.

12. The method of claim 1, wherein b) includes depositing a metal line profile through a vacuum evaporation process.

13. The method of claim 1, wherein b) includes depositing a metal line profile through a sputtering process.

14. The method of claim 1, wherein b) includes depositing a metal line profile, wherein the metal line profile is composed of aluminum.

15. The method of claim 1, wherein b) includes depositing a metal line profile, wherein the metal line profile is composed of silver.

16. The method of claim 1, wherein b) includes a metal line profile with a thickness in the range of 25 nm to 120 nm.

17. The method of claim 1, wherein b) includes depositing a metal line profile at an oblique angle to the normal of the substrate in the range of 35° to 55°.

18. The method of claim 1, wherein b) includes one or more baffles with an aspect ratio in the range of 2.5 to 4.5.

19. A wire grid polarizer, comprising
a) a substrate with a plurality of raised ridges formed by embossing the surface of the substrate with a mold having a plurality of grooves; and
b) a plurality of metal lines on the raised ridges, wherein the plurality of metal lines are characterized by cross-sectional metal line profiles having triangular shapes with a tip down configuration.

20. The wire grid polarizer of claim 19, wherein the substrate is made of a polycarbonate transparent polymer material.

21. The wire grid polarizer of claim 19, wherein the substrate is made of a triacetate cellulose transparent polymer material.

22. The wire grid polarizer of claim 19, wherein the substrate is made of a PET transparent polymer material.

23. The wire gird polarizer of claim 19, wherein the substrate has a thickness in the range of 50 μm to 300 μm.

24. The wire grid polarizer of claim 19, wherein the plurality of raised ridges are characterized by a periodicity in the range of 50 nm to 200 nm.

25. The wire grid polarizer of claim 19, wherein the plurality of raised ridges are characterized by a height in the range of 60 nm to 160 nm.

26. The wire grid polarizer of claim 19, wherein the plurality of raised ridges are narrow and have a slight convex curvature near the top of the narrow ridges.

27. The wire grid polarizer of claim 19, wherein the plurality of raised ridges are narrow and the sidewalls of the narrow ridges have a slight concave curvature.

28. The wire grid polarizer of claim 19, wherein the plurality of metal lines are made of aluminum.

29. The wire grid polarizer of claim 19, wherein the plurality of metal lines are made of silver.

30. The wire grid polarizer of claim 19, wherein the plurality of metal lines have a metal line profile with a thickness in the range of 25 nm to 120 nm.

31. A liquid crystal display (LCD) comprising:
a) a backlight assembly configured to provide unpolarized illumination and process reflected illumination of a polarization orthogonal to the desired polarization so that the reflected illumination re-emerges as unpolarized illumination;
b) a wire grid polarizer configured to transmit illumination from the backlight assembly that is of a desired polarization and reflect illumination from the backlight assembly that is of a polarization orthogonal to that of the desired polarization back to the backlight, wherein the wire grid polarizer comprises:
a substrate with a plurality of raised ridges formed by embossing the surface of the substrate with a mold having a plurality of grooves; and
a plurality of metal lines on the raised ridges, wherein the plurality of metal lines are characterized by cross-sectional metal line profiles having triangular shapes with a tip down configuration; and
c) a liquid crystal panel assembly configured to transmit illumination from the wire grid polarizer to a viewer.

32. The LCD of claim 31, wherein the backlight assembly includes a light source.

33. The LCD of claim 32, wherein the backlight assembly further includes a light guide that directs illumination from the light source.

34. The LCD of claim 32, wherein the backlight assembly further includes a diffuser to homogenize the spatial variations in the intensity of the light emanating from the light source.

35. The LCD of claim 31, wherein the substrate is made of a polycarbonate polymer material.

36. The LCD of claim 31, wherein the substrate is made of a triacetate cellulose transparent polymer material.

37. The LCD of claim 31, wherein the substrate is made of a PET transparent polymer material.

38. The LCD of claim 31, wherein the substrate has a thickness in the range of 50 μm to 300 μm.

39. The LCD of claim 31, wherein the plurality of raised ridges has a periodicity in the range of 50 nm to 200 nm.

40. The LCD of claim 31, wherein the plurality of raised ridges has a height in the range of 60 nm to 160 nm.

41. The LCD of claim 31, wherein the plurality of raised ridges are narrow and have a slight convex curvature near the top of the narrow ridges.

42. The LCD of claim 31, wherein the plurality of raised ridges are narrow and the sidewalls of the narrow ridges have a slight concave curvature.

43. The LCD of claim 31, wherein the plurality of metal lines are made of aluminum.

44. The LCD of claim 31, wherein the plurality of metal lines are made of silver.

45. The LCD of claim 31, wherein the plurality of metal lines are characterized by a metal line profile with a thickness in the range of 25 nm to 100 nm.

46. The LCD of claim 31, wherein the liquid crystal panel assembly includes a liquid crystal array configured to accept the illumination transmitted by the wire grid polarizer, whereupon depending on the voltage applied to each liquid crystal pixel of the liquid crystal array, the plane of polarization of the incident illumination is either rotated or not.

47. The LCD of claim 46, wherein the liquid crystal panel assembly further includes an absorptive polarizer that transmits the light emanating from the liquid crystal array in proportion to the degree of polarization rotation imparted by the liquid crystal pixels.
